(19) United States
(12) Patent Application Publication
(10) Pub. No.: US 2012/0052286 A1
(43) Pub. Date: Mar. 1, 2012

(54) MAGNETIC-NANOPARTICLE-POLYMER COMPOSITES WITH ENHANCED MAGNETO-OPTICAL PROPERTIES

(76) Inventors: Robert A. Norwood, Tucson, AZ (US); Jayan Thomas, Tucson, AZ (US); Palash Gangopadhyay, Tucson, AZ (US); Alejandra Lopez-Santiago, Tucson, AZ (US)

(21) Appl. No.: 13/320,020

(22) PCT Filed: May 14, 2010
(86) PCT No.: PCT/US10/35002

§ 371 Date: Nov. 10, 2011

Related U.S. Application Data
(60) Provisional application No. 61/216,197, filed on May 14, 2009.

(51) Int. Cl. B32B 5/16; H01F 1/00; B82Y 30/00

(52) U.S. Cl. 428/323; 252/62.54; 977/902

(57) ABSTRACT

Composites, designed “MNPC” materials, are formed by methods of which an exemplary method includes preparing a liquid suspension of magnetic nanoparticles in a carrier liquid in which the nanoparticles are not soluble. The carrier liquid can form a rigid polymer matrix for the nanoparticles whenever the carrier liquid is exposed to a rigidification condition. A first rigidification condition is applied to the suspension to rigidify the carrier liquid into the polymer matrix and thus form a rigid MNPC material. A fluidizing condition is applied to the rigid MNPC material to fluidize the matrix and allow movement of the nanoparticles in the matrix. While the matrix is fluid, the MNPC material is magnetically poled by exposure to an external magnetic field. Poling aligns at least some of the nanoparticles with the field and allows at least some particles to self-assemble with each other. While continuing the magnetic poling, a second rigidification condition is applied to the MNPC material to freeze further movement of the nanoparticles in the polymer matrix. The produced materials have enhanced properties including magneto-optical properties.

### CROSS-REFERENCE TO RELATED APPLICATION

This application claims priority to and the benefit of U.S. Provisional Patent Application No. 61/216,197, filed May 14, 2009, incorporated herein by reference in its entirety.

### STATEMENT OF GOVERNMENT SUPPORT

This invention was made with Government support under grant number FA9550-06-1-0039 awarded by the U.S. Air Force Office of Scientific Research. The Government has certain rights in the invention.

### FIELD

The present disclosure pertains to, inter alia, methods for fabricating materials comprising magnetic (metal or metal-oxide) nanoparticles embedded in a host matrix, wherein the nanoparticles are magnetically oriented and assembled into particular structures in the matrix, such as but not limited to 1D, 2D, and 3D structures.

### BACKGROUND

The design, synthesis and study of nanocomposite materials comprising magnetic nanoparticles embedded, particularly in a predetermined ordered manner, in a non-magnetic “host matrix” have attracted significant interest over the last decade. “Magnetic” nanoparticles can include one or more of the following: para-, superpara-, and ferro-magnetic nanoparticles, and have a size range within conventional bounds for “nano”-sized particles. In this regard, a “nanocomposite” material is a material comprising nanoparticles embedded in, suspended in, or otherwise structurally associated with a different “host material,” such as an organic polymer. An important group of these materials includes magneto-optic (MO) nanocomposites, which exhibit magneto-optical behavior under defined conditions and configurations. Exemplary magnetic materials from which the nanoparticles are made include, but are not limited to, Fe, Co, γ-Fe₂O₃, Fe₃O₄, and CoFe₂O₄. Example host materials include but are not limited to various organic polymers, silicone polymers, silica gels, colloidal silica particles, glass, and ion-exchange resins.

Examples of MO nanocomposites comprising Fe, Co, γ-Fe₂O₃, Fe₃O₄, or CoFe₂O₄ nanoparticles are discussed in these respective publications: Gonsalves et al., “Magneto-optical Properties of Nanostructured Iron,” J. Materials. Chem. 7(5):703-704 (1997); Kalska et al., “Magneto-optics of Thin Magnetic Films Composed of Co Nanoparticles,” J. Appl. Phys. 92:7481(2002); Guerrero et al., “Faraday Rotation in Magnetic γ-Fe₂O₃/SiO₂ Nanocomposites,” Appl. Phys. Lett. 71(18):2698-2700 (1997); Barnakov et al., “Spectral Dependence of Faraday Rotation in Magnetite-Polymer Nanocomposites,” J. Phys. Chem. Solids. 65(5):1005-1010 (2004); and Stichauer et al., “Optical and Magneto-Optical Properties of Nanocrystalline Cobalt Ferrite Films,” J. Appl. Phys. 79(7):3645-3650 (1996). Examples of MO nanocomposites in which the host material is an organic polymer and an ion-exchange resin are discussed in these respective publications: Smith et al., “Magneto-optical Spectra of Closely Spaced Magnetite Nanoparticles,” J. Appl. Phys. 97:10 M504-01-10M504-3 (2005) and Ziolo et al., “Matrix-Mediated Synthesis of Nanocrystalline γ-Fe₂O₃: A New Optically Transparent Magnetic Material,” Science 257(5067):219-223 (1992).

A substantial need exists for methods for manufacturing nanocomposite materials in which the magnetic and/or optical properties of the embedded nanoparticles and the processability of the host material can be exploited in the practical manufacture of useful devices. For example, a need exists for methods for manufacturing MO-active nanocomposite devices that can be used in, for example, magnetic field sensors, integrable optical isolators, polarizers, and rotators, high-speed MO modulators, and information storage (e.g., as used in data-storage devices comprising MO-active nanocomposite media).

For example, a composite of γ-Fe₂O₃ nanoparticles in an organic resin absorbs less incident electromagnetic radiation than bulk γ-Fe₂O₃ particles. Ziolo et al., “Matrix-Mediated Synthesis of Nanocrystalline γ-Fe₂O₃: A New Optically Transparent Magnetic Material,” Science 257(5067):219-223 (1992). Also, Fe nanoparticles suspended in a matrix material produce a larger MO effect than the bulk Fe particles, and the magnitude of the MO effect appears to be dependent both on particle density and the characteristics of the interfaces of the particles with the host material. Sepulveda et al., “Linear and Quadratic Magneto-optical Kerr Effects in Continuous and Granular Ultrathin Monocrystalline Fe Films,” Phys. Rev. B 68:064401 (2003), and Jiang et al., “Magnetooptical Kerr Effect in Fe—SiO Granular Films,” J. Appl. Phys. 78(1):439-441 (1995).

Although the properties of isolated single-domain magnetic nanoparticles are relatively well understood, the competition between single-particle responses and correlation effects produced by multiple particles in nanocomposites of such particles continues to be an area of intense research. One technique for incorporating magnetic nanocomposite materials in a uniformly and/or randomly distributed manner in a polymer matrix is described in PCT/US2010/029689, incorporated herein by reference. Specifically, the PCT '689 application discusses producing a uniform dispersion of the nanoparticles in a polymeric host material with minimal clustering of the magnetic nanoparticles, followed by rigidification of the host material to inhibit migration and/or aggregation of the nanoparticles. Production of the uniform dispersion is facilitated by forming a polymer shell around each nanoparticle before dispersing the particles in a resin or the like for forming the polymeric host material. Nanoparticles having such shells are termed “nanoparticle-core polymer-shell” (NC-PS) nanocomposite particles.

During or after producing a rigid nanocomposite polymeric material comprising a dispersion of nanoparticles in a polymer matrix, it is desirable in certain applications to achieve a degree of orientation and/or organization of the nanoparticles in the dispersion or in a particular region of the dispersion. Each nanoparticle behaves as an individual magnetic dipole. Producing a common magnetic orientation of the nanoparticles, at least in a particular region of a nanocomposite material, can produce a nanocomposite material exhibiting enhanced properties. Magnetic orientation of the particles is performed using a magnet. But, in certain applications this magnetic reorientation should or must be performed after the polymer matrix material has rigidified (hardened or cured, depending upon the particular polymer). Usually, a rigidified matrix material holds the particles so tightly that they cannot be reoriented even upon being exposed to a strong magnetic field. Also, after the nanoparticles are reoriented, they desirably are rendered into a condition in which the reorientation and/or reorganization is preserved.

U.S. Pat. No. 6,086,780 discusses field-induced orientation of magnetic nanoparticles dispersed in kerosene. But, since the kerosene does not harden or rigidify, permanence of the orientation cannot be achieved. In other words, the kerosene remains a fluid in which the nanoparticles can move and change orientation. Thus, the assembly-induced structure of the dispersion is lost whenever the external applied magnetic field is removed or turned off. These materials are not suitable for many applications or in situations in which a permanency or at least storability of the self-induced assembly is needed or desired.

Recent interest has focused on using magnetic nanoparticle-based ferrofluids and composites for applications ranging from electronics and optical communications to medical research. One of the important requirements for these applications is the assembly of these particles into an ordered 3D arrangement within a host matrix. For example, although orientation and reshaping of cobalt nanoparticles using an applied magnetic field has been demonstrated, J. Materials Sci. 13:1803 (2003), such effects are not known to have been exploited to optimize the optical and MO properties of the resultant structure.

### SUMMARY

The needs summarized above are met by, inter alia, materials produced according to methods as disclosed herein. The needs are also met by methods, as disclosed herein, for forming such materials.

Materials as disclosed herein are termed “magnetic-nanoparticle-polymer composites” (abbreviated MNPC materials). A unit of such a material comprises a rigid polymer matrix and multiple magnetic nanoparticles suspended in the matrix. At least some of the magnetic nanoparticles are magnetically oriented in the matrix, and at least some of the magnetic nanoparticles are self-assembled into ordered structures including but not limited to substantially one-dimensional stacks of the nanoparticles. In many of these materials, the polymer matrix is sufficiently thermoplastic to allow the polymer to be fluidized, typically by application of heat. The degree of fluidization of the polymer is sufficient to allow the orientations and self-assembled status of the nanoparticles in the matrix to be established or changed, typically by application of an external magnetic field to the fluidized polymer (a process called “magnetic poling”). For example, the materials can be made as “pristine” MNPC materials in which the magnetic nanoparticles are substantially randomly distributed in a rigid polymer material, followed by fluidization of the polymer and magnetic poling to orient and self-assemble the nanoparticles with each other while the polymer is fluid, and then followed by rigidification of the polymer to “freeze” the nanoparticles in their established orientations and order. Thermoplastic polymers also allow the MNPC material to be “repoled,” if necessary or desired, to change the orientations and/or order of the nanoparticles or to refresh their previously established order and orientation.

The subject MNPC materials exhibit remarkably enhanced magneto-optical (MO) properties such as but not limited to enhanced Faraday rotation. These properties confer special utility of the MNPC materials for use in any of various MO devices including but not limited to MO isolators, MO modulators, MO switches, satellite-altitude monitors, magnetic-field-uniformity probes, sensitive engine monitors, electrical-power sensors and monitors, pacemaker-warning devices, and other magnetic-field-sensing devices.

The MNPC materials are produced by any of various embodiments of methods disclosed herein. One embodiment comprises producing a pristine MNPC material comprising magnetic nanoparticles suspended in a polymer matrix. At least one portion of the pristine MNPC material is exposed to a fluidizing condition to liquefy the polymer matrix in the at least one portion, wherein the liquefaction is sufficient to allow movement of the nanoparticles in the matrix. During exposure to the fluidizing condition, the at least one portion is magnetically poled to magnetically align the constituent nanoparticles with an external magnetic field applied to the at least one portion and to cause at least some of the nanoparticles in the at least one portion to self-assemble with each other. While continuing the magnetic poling, the at least one portion is exposed to a rigidification condition to freeze further movement of the nanoparticles in the at least one portion.

In another embodiment, a suspension is prepared of magnetic nanoparticles in a liquid that, when exposed to a rigidification condition, forms a rigid polymer matrix for the nanoparticles. In the suspension the magnetic nanoparticles are substantially randomly distributed. But, instead of rigidifying the liquid before performing magnetic poling, magnetic poling is performed while the suspension is still fluid. During magnetic poling the nanoparticles become oriented to the magnetic field and self-assemble into at least 1-dimensional (1D) ordered structures such as pillars or stacks having large shape anisotropy. Application of a subsequent rigidification step, desirably performed while continuing exposure to the external magnetic field, freezes the nanoparticles in their established structures and orientations.

The foregoing and additional features and advantages of the subject methods will be more readily apparent from the following detailed description, which proceeds with reference to the accompanying drawings.

### BRIEF DESCRIPTION OF THE DRAWINGS

FIG. 1 is a schematic flow-diagram of an embodiment of a method for preparing “pristine” films of a magnetic-nanoparticle-polymer composite (MNPC) particle. A “pristine” film or other unit of MNPC material is one that has not yet been subject to post-processing orientation and/or organization of at least some of the nanoparticles in the material.

FIG. 2(A) is a transmission electron micrograph of Fe₃O₄ nanoparticles as suspended in a polymer matrix configured as a film.

FIG. 2(B) is a bar graph of the size distribution of the nanoparticles, shown in FIG. 2(A), having a mean diameter of 11 nm.

FIG. 2(c) is an electron micrograph of a single Fe₃O₄ nanoparticle, revealing its high degree of crystallinity and shape anisotropy.

FIG. 2(D) is an atomic force microscopy (AFM) image of the surface of the film of FIG. 2(A).

FIG. 3(A) is a plot of respective Faraday rotations as a function of wavelength exhibited by MNPC materials containing 1 wt % Fe₃O₄ nanoparticles having mean diameters of 15 and 40 nm.

FIG. 3(B) is a plot of Faraday rotation as a function of wavelength exhibited by a 5 wt % MNPC material containing 11 nm Fe₃O₄ nanoparticles in poly-butylmethracrylate. Signs (+ or −) of the Faraday rotation are not shown.

FIG. 4 is a plot of Faraday rotation versus magnetic flux density, showing that a magneto-optic (MO) response is substantially larger in the MNPC films compared to solutions containing otherwise similar concentrations (vol. %) of Fe₃O₄ nanoparticles.

FIG. 5 is a schematic diagram detailing an embodiment of magnetic-field poling as performed on a pristine film of MNPC material, resulting in formation of 1D “pillars,” or stacks of nanoparticles, within the polymer matrix.

FIGS. 6(A)-6(C) are respective scanning electron micrographs of a magnetically poled MNPC film, showing the substantially 1D organization (individual stacks) of the constituent nanoparticles in the polymer matrix.

FIG. 7 is a plot of Faraday rotation as a function of magnetic field density as exhibited by several materials including three MNPC materials produced by the subject methods. The respective Verdet constants of the materials are also provided and compared to the commercially available benchmark material terbium-doped gallium garnet (TGG).

FIG. 8(A) is a schematic diagram showing an embodiment of a method for performing magnetic poling of nanoparticles in a pristine MNPC material, using a superlattice. A “superlattice” is a periodic structure of layers of two or more materials. Typically, the thickness of one layer is several nanometers.

FIG. 8(B) is a schematic diagram showing details of an embodiment of a method for controllably forming a superlattice.

FIG. 9(A) is a topographic image of a photonic crystal material prepared by a nano-imprinting method as applied to a pristine MNPC material comprising Fe₃O₄ in PMMA. “Nanoimprinting” is a method of fabricating nanometer-scale patterns.

FIG. 9(B) is an MFM (magnetic force microscopy) image of the same film shown in FIG. 9(A). This image shows that individual pillars of nanoparticles have magnetic responses that are independent of each other upon application of an external magnetic field, such as that produced in a magnetic force microscopy tip. The darker regions denote repulsion between the magnetic tip and the sample.

FIG. 10(A) is a schematic diagram of an embodiment of an optical isolator, made as described herein, that uses Faraday rotation as exhibited by a constituent MNPC.

FIG. 10(B) is a schematic diagram of a second embodiment of an optical isolator specifically configured for high-power applications.

### DETAILED DESCRIPTION

This disclosure is set forth in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another. The disclosed things and methods are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Methods are disclosed for preparing magnetic-nanoparticle polymer-composite (MNPC) materials in which at least some of the nanoparticles in the material (or in a selected region of the material) are oriented in the same direction according to an externally applied magnetic field and/or are organized into specific structures such as but not limited to pillars, columns, stacks, and the like. These structures typically are oriented with respect to the applied magnetic field. The materials can be of any of various forms, including but not limited to films and other convenient or practical bulk shapes. In such a material and/or in any selected region of the material, the magnetic nanoparticles are organized magnetically, resulting from a self-organization of the particles resulting from application of an external magnetic field. These MNPC materials exhibit various useful properties, including but not limited to enhanced magneto-optical (MO) properties. Enhanced MO behavior is evidenced by, for example, greater Faraday rotation, compared to MNPC materials containing randomly oriented magnetic nanoparticles, or compared to materials having no nanoparticles at all. The material may exhibit a variety of other MO effects, the most notable of which is the MO Kerr effect.

Formation of a “pristine” MNPC material (material not yet subjected to magnetic poling) can be performed by a method such as described in PCT/US2010/029689, incorporated herein by reference. The methods in PCT '689 involve forming a suspension of nanoparticle core-polymer shell (NC-PS) particles, adding to the suspension one or more monomers for forming the polymer matrix material, and then curing the monomers to rigidify (cure) the polymer matrix. However, formation of a pristine material is not limited to the PCT '689 method. The pristine MNPC material can be made using any technique that produces a suspension or other arrangement of magnetic nanoparticles in a matrix material that can be melted or fluidized to a desired degree for performing a magnetic poling process on the material. Also, whereas the PCT '689 application describes nanoparticles having polymer shells, the nanoparticles used in the MNPC materials disclosed herein need not have polymer shells. Generally, in the pristine MNPC material the magnetic nanoparticles are randomly distributed and tend to have random orientations.

In an embodiment of a method as described herein, pristine MNPC material is formed having a desired composition of polymer (particularly type of polymer(s) and any additives such as but not limited to plasticizers and/or dispersants). The pristine MNPC material also comprises magnetic nanoparticles of a particular size(s), size distribution(s), and concentration(s) (in units of wt %). The pristine MNPC material is then subjected to “magnetic poling,” in which a unit of the material is heated to a temperature that causes at least partial melting or softening of the material sufficient for movement of the nanoparticles in the polymer matrix. Upon reaching a desired degree of matrix fluidity, the MNPC material is exposed to an applied external magnetic field having a desired magnitude and direction to cause at least some of the nanoparticles to align with the field. (The attained degree of fluidity depends upon various factors including but not limited to the particular polymer(s), their degree of cross-linking, if any, their molecular weight, the applied temperature, presence or absence of plasticizer, type of plasticizer, concentration of plasticizer, the applied temperature, etc. Actual attained fluidity is typically rather viscous.) The softening temperature and magnetic-field strength are selected to enable the nanoparticles in the heated material to orient themselves with the magnetic field, and to organize and/or assemble with each other to create ordered structures of the nanoparticles in the polymer matrix. This organization and/or assembly normally occurs as a “self” (spontaneously occurring) process. The external magnetic field desirably is applied to the MNPC material while the material is at a temperature that is above its melting temperature or its “critical softening” temperature (temperature at which the nanoparticles can move sufficiently to orient and/or organize themselves under the influence of the magnetic field).

The ideal magnetic field would be highly uniform over the poling region with a strength sufficient to achieve saturation of the orientation effect. The preferred orientation of the field depends on the intended use of the films, i.e., whether it is for waveguide or free-space applications. For free-space applications the preferred orientation is normal to the plane of the film, while for waveguides it is in the plane of the film. While continuous fields applied for relatively long periods of time (minutes +) have been used, certain applications may benefit from using intense pulsed fields, together with rapid cooling, which would permit high orientation with low aggregation.

An ideal matrix polymer has very low optical loss at the operational wavelengths of interest (<1 dB/cm), a good refractive-index match to the nanoparticles (within approximately 0.03), very low birefringence (<0.001), and excellent thermal and mechanical properties.

Organization and/or assembly of the nanoparticles can also be facilitated or even optimized by including at least one plasticizer or analogous compound in the unit of MNPC material. Exemplary plasticizers include but are not limited to ethyl carbazole and diisophthalate. The plasticizer can be added during formation of the pristine MNPC material or can be applied to an MNPC material before or as the material is heated for magnetic poling. Including a plasticizer, particularly as the MNPC material is being formed, can also allow reduction of the temperature to which the MNPC material must be heated during magnetic poling. The plasticizer(s) tend to reduce the viscosity of the polymer, which helps to increase the translational order of the magnetic nanoparticles that can be achieved in the melt at a particular magnitude of applied magnetic field.

After achieving the desired objective of magnetic poling, such as a desired degree of self-organization of the nanoparticles, the MNPC material is cooled while still being exposed to the magnetic field (which can be the same magnitude as applied to the fluidized MNPC material or a different magnitude). Cooling preserves the organization of the nanoparticles achieved during magnetic poling. The rate and duration of cooling are largely dependent on the particular polymer host matrix used and on its ability to harden or rigidify sufficiently as the temperature thereof is reduced. Rigidifying or hardening the host matrix while continuing application of the magnetic field prevents the nanoparticles from returning to their initial orientations in the matrix, and prevents loss of the structures formed by the nanoparticles in the matrix. To such end, application of the magnetic field desirably is continued until the material is fully cooled from the fluidization temperature to a temperature at which particle reorientation and/or movement does not occur to any significant extent.

This process of orientation and self-organization/assembly is analogous in some respects to electrical-field poling. The primary difference between magnetic-field poling and its electrical-field counterpart is the absence of charge injection during the magnetic-field poling process. Charge injection is a significant additional factor that must be managed in the electrical-field poling case.

The degree of self-organization achieved by the nanoparticles during magnetic poling appears to depend, at least in part, on the shape anisotropy and size distribution of the particles in the host matrix, the particular elevated temperature of the MNPC material relative to its melting point, and on the amplitude of the applied external magnetic field.

Magnetically poled composite materials in which the nanoparticles have been oriented and assembled can be used for, or in, any of various MO devices, including but not limited to: MO isolators, MO modulators, MO switches, satellite-altitude monitors, magnetic-field-uniformity probes, sensitive engine monitors, electrical-power sensors and monitors, pacemaker-warning devices, and other magnetic-field-sensing devices. Certain of these devices are discussed later below.

In nano-structured materials comprising nanometric-sized particles, dipolar interactions among the particles play an important role in controlling long-range interactions among the particles and in determining cooperative phenomena exhibited by the material at the nanometer scale. The interplay of these interactions among the nanoparticles and the resulting final properties of the MNPC materials are of great interest. For example, dense interactive assemblies of magnetic nanoparticles are magnetically “soft” and behave very differently than individual isolated nanoparticles. These assemblies tend to form large-area magnetic domains and tend to behave as ferromagnetic materials. This behavior persists so long as the assemblies have finite shape anisotropy.

The methods disclosed herein are the first known that include magnetically poling a unit of pristine MNPC material to induce 1D, 2D, and/or even 3D assembly of the magnetic nanoparticles with each other to produce a useful composite material (e.g., a material exhibiting high-efficiency MO behavior). One of the key obstacles to attaining a high degree of order in magnetically “assembled” nanoparticle structures is that the particles need to have enough mobility to orient themselves, move, and associate with one another relative to the lines of force of the applied magnetic field. As described below, this problem is solved by exposing the MNPC material to an externally applied magnetic field while the polymer component of the material is in a melted or otherwise sufficiently fluid state.

Magnetic nanoparticles suspended in a fluid matrix material may lose their assembly-induced order they may have achieved by magnetic poling. This loss begins as soon as the external magnetic field is removed away or turned off. To solve this problem, in the current methods the polymer host material is cooled (rigidified) while continuing exposure to the magnetic field, thereby “freezing” the established spatial self-assembly of the particles as material cools to a temperature at which the self-assembly is not able to change after removing or turning off the magnetic field. The resulting nanocomposite material retains the established order of the constituent nanoparticles. As an example of nanoparticle order, during magnetic poling the nanoparticles in the fluidized MNPC material are rearranged into a nanostructure useful for optimizing the MO properties of the material. An example such structure comprises stacks and/or pillars of nanoparticles exhibiting para- and super-paramagnetic behavior. Paramagnetism is a form of magnetism that occurs only in the presence of an externally applied magnetic field. Ferromagnetism occurs when an external magnetic field is able to magnetize the nanoparticles, similarly to a paramagnet but with a much larger magnetic susceptibility.

Pillars and arrangements thereof are examples of 1D and 2D, respectively, arrangements of stacked nanoparticles. The pillars have large shape anisotropy and large collective magnetization.

Magnetic poling desirably is applied to the MNPC material at a temperature at which the magnetic nanoparticles in the material are movable under the influence of the applied magnetic field. The typical MNPC material at time of commencing magnetic poling comprises a random dispersion of magnetic nanoparticles, for example Fe₃O₄ nanoparticles, embedded in the matrix material. Magnetic poling produces orientation and at least partial ordering of the nanoparticles in the matrix. Forming a particular ordered arrangement can be facilitated by using a corresponding “design template,” as discussed later below. The resulting “poled” material exhibits one or more enhanced MO properties, such as enhanced Faraday rotation, which is an MO property useful for various applications.

Faraday rotation is the rotation of the polarization plane of linearly polarized laser light produced by the material due to circular birefringence of the material produced by a magnetic field applied to the material. Faraday rotation can be mathematically described by the Faraday law: θ=(±)V(±)BL=πLΔn/λ, wherein B is the magnitude of the applied magnetic field, L is the thickness of the MNPC film, V is the Verdet constant of the material, θ is the degree of polarization imparted by the material to incident coherent light (the polarization rotation can be left or right), λ is the wavelength of the light, and Δn is the change in refractive index exhibited by the material. The Verdet constant (V) is a materials property that depends upon the wavelength (λ) of the incident light. The Verdet constant can be calculated from the Faraday equation above. With para-magnetic and super-paramagnetic materials the Verdet constant is also a function of the frequency of the applied magnetic field. Thus, the Verdet constant is directly related to magnetization imparted to the material. The Verdet constant in such materials is a function of the size and shape anisotropy of the material achieved by magnetic poling, and of the magneto-optically allowed optical transitions (Δlt=±1, Δm=±1) of the material.

In one example, measurements of Faraday rotation were obtained from films of various thicknesses prepared from MNPC materials containing Fe₃O₄ nanoparticles suspended in a polymer matrix. The measurements were obtained using MO polarimeters biased with AC and DC magnetic fields. The Fe₃O₄ nanoparticles had average diameters of 11, 15, and 40 nm. Each such material was made having a respective one of three different concentrations of nanoparticles, namely 1, 5, and 10 wt %. The polymers in the MNPC materials were dispersed were poly-isobutylmethacrylate and poly-methylmethacrylate of various molecular weights in the range of 7500 to 350,000 daltons. Initial polymerizations were performed in situ with dispersions of the nanoparticles in liquid monomers (isobutylmethacrylate and methylmethacrylate). The resulting pristine MNPC materials were melted and formed into films.

The films were imaged using atomic force microscopy (AFM) and magnetic force microscopy (MFM), and evaluated by UV-VIS spectrophotometry and measurements of refractive index. For magnetic poling, the films were controllably heated to a temperature several degrees above their respective melting points while being exposed to an external magnetic field having a predetermined flux density C. Magnetic poling caused the nanoparticles to self-organize into one-dimensional stacks and arrays thereof, which resulted in a stronger overall magnetization of the particles. The films were then cooled while continuing to apply the magnetic field to preserve the orientation and organization of the nanoparticles in the films.

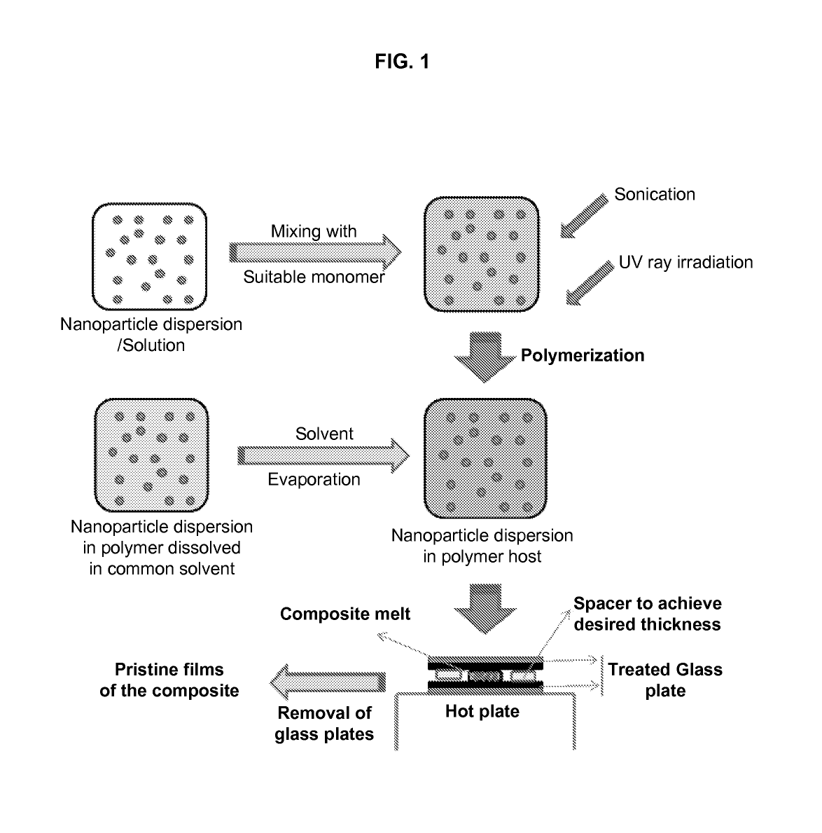

FIG. 1 is a schematic diagram of an embodiment of a process for preparing a unit of “pristine” MNPC material, in this instance a film suitable for subsequent magnetic poling. Forming the MNPC material starts with forming a dispersion of the magnetic nanoparticles in a suitable fluid carrier, which desirably is a solvent or solvent mixture appropriate for the polymer(s), or for making a solution of the polymer(s). The dispersion can be prepared in either of two ways. A first way involves suspending the nanoparticles in an organic solvent (or solvent mixture) in which the nanoparticles are not soluble but in which the intended monomer(s) is soluble. The relative amounts of nanoparticles and solvent are selected to produce a desired concentration of the particles in the solvent. Then, one or more monomers, soluble in the solvent, are added to form a monomer solution in which the nanoparticles are suspended. To maintain the dispersion, the suspension is agitated (e.g., by sonication) while being irradiated with a suitable polymerization-inducing wavelength of electromagnetic radiation (e.g., UV light) to cause the molecules of the monomer(s) to polymerize, thereby producing a dispersion of the nanoparticles in a rigid polymer host. A second way involves suspending the nanoparticles in a solution of a polymer(s) dissolved in a suitable solvent or solvent mixture in which the nanoparticles are not soluble. The solvent is then evaporated to rigidify the remaining polymer, thereby producing a dispersion of the nanoparticles in a rigid polymer host. Both of these techniques produce respective “pristine” MNPC materials that can be magnetically poled later.

Magnetic poling need not be postponed. With either technique described above, it is possible to magnetically pole the dispersion as polymerization is progressing. Thus, when polymerization is complete a magnetically poled MNPC material is produced in which the nanoparticles are oriented and self-organized into useful structures. Magnetic poling performed during polymerization is advantageous if the polymer is a thermoset. Thermoplastic polymers can be “melted,” and hence readily undergo fluidization when magnetic poling is performed after the polymer has been formed.

In an example embodiment, pristine films were formed by a method in which a unit of the respective MNPC material was placed between two glass plates. The glass plates were treated beforehand with a release agent (e.g., a silicone). The plates were separated from each other by spacers to produce a desired gap between the plates. The gap corresponded to the desired film thickness. The unit of MNPC material was sized to fill the gap when the MNPC material was melted. For melting the polymer in the unit of MNPC material, the paired plates were placed on a temperature-controlled surface (e.g., “hot plate”). When the MNPC material reached the temperature of the surface, the respective unit of MNPC material was melted or at least sufficiently fluidized to form a film occupying the gap between the plates. After cooling, the plates were separated from each other, and the newly formed “pristine” film was removed.

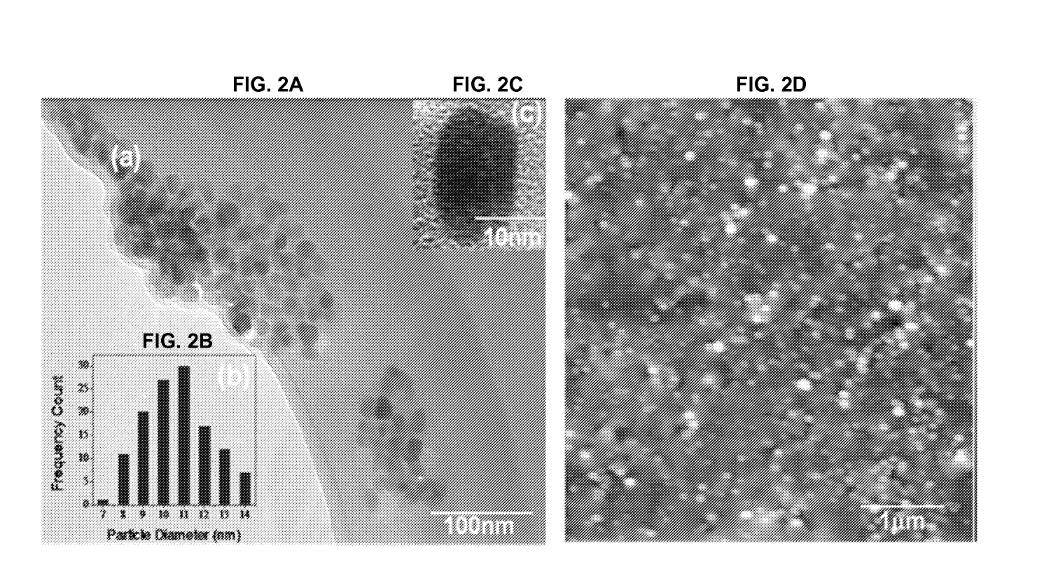

FIG. 2(A) is a transmission electron microscopy (TEM) image of a quantity of nanoparticles in an exemplary pristine MNPC film having a thickness of 23 μm. FIG. 2(B) is a plot of the size distribution of the 11-nm nanoparticles in this film. A TEM image of a single nanoparticle is shown in FIG. 2(C), showing the particle having a high degree of crystallinity and an anisotropic shape. FIG. 2(D) is an AFM topographic image of the surface of the pristine MNPC film. The image shows a nearly homogeneous top surface with an RMS surface roughness of less than 5 nm. An MFM image of the same material revealed that the material exhibited magnetization behavior similar to large area domains.

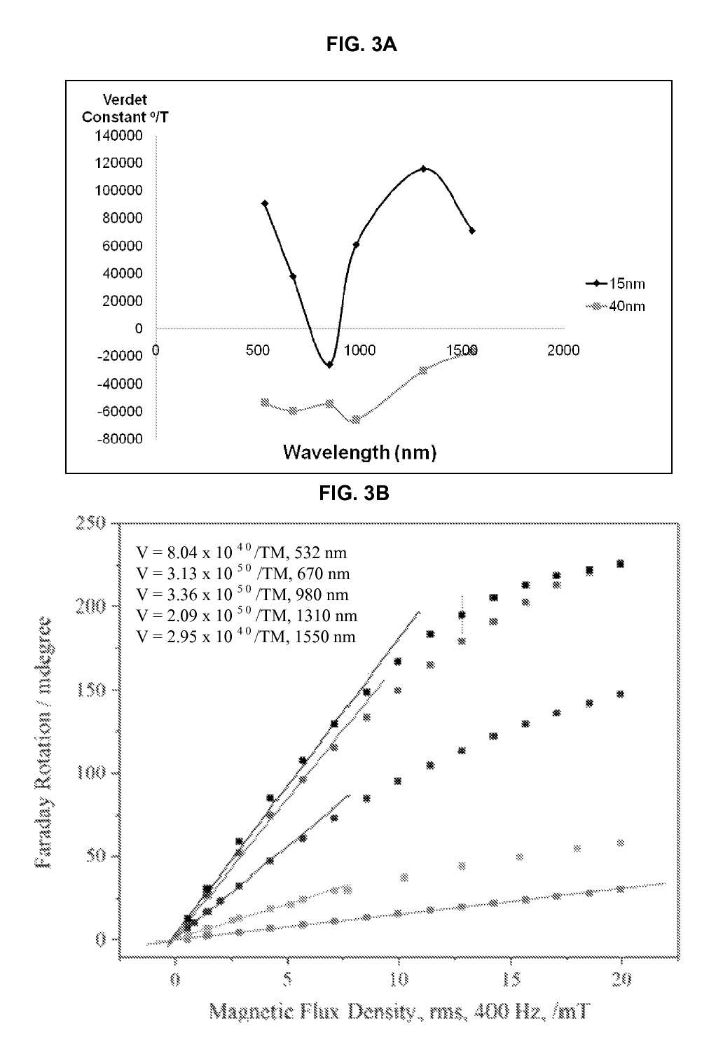

FIG. 3(A) shows representative wavelength-dependent plots of the Verdet constants, indicating respective amounts of Faraday rotation exhibited by pristine MNPC films of 1 wt % nanoparticles having diameters of 15 and 40 nm. In a liquid medium such as a solution or a ferrofluid, magnetic nanoparticles are oriented randomly. This is due to Brownian motion of the particles, which is dominant at room temperature. In a rigid polymer host, in contrast, such as in these pristine films, the magnetic nanoparticles are spatially frozen. Spatially frozen nanoparticles, even if randomly arranged, are subject to effects having greater influence than Brownian motion. These effects include but are not limited to proximity (matrix) effects, long-range particle-particle interactions, collective particle behavior, percolations, and correlated local and global interactions among the particles.

The magnetic nanoparticles, even in a rigid polymer host, can be organized in 1D, 2D, or even 3D arrangements as a result of induced ordering of the particles caused by the magnetic field. Example 1D arrangements are pillars, stacks, and the like each containing multiple nanoparticles. Example 2D and 3D arrangements are regions of pillars. The long-range interactions between nanoparticles in such ordered structures can be exploited in various useful ways. The particular nature and morphology of the ordered arrangements can be selected to produce a desired net behavior of the composite. Although ordering may impede the ability to influence magnetic properties of a single nanoparticle, the ordering can induce much larger collective magnetizations among the particles that is useful, for example, in enhancing the MO properties of the material. In an ordered magnetic material, individual magnetic nanoparticles cooperatively enhance the bulk magnetization through long-range interactions referred to as “collective magnetism.” Reference is now made to FIG. 3(B), which shows Faraday rotation as a function of wavelength (at various flux densities of applied magnetic field) for pristine MNPC films containing 5 wt % 11-nm Fe₃O₄ nanoparticles in poly-isobutylmethacrylate. In the figure, the signs (+ or −) of Faraday rotation are omitted. The maximum Verdet constant found was approximately 980 nm.

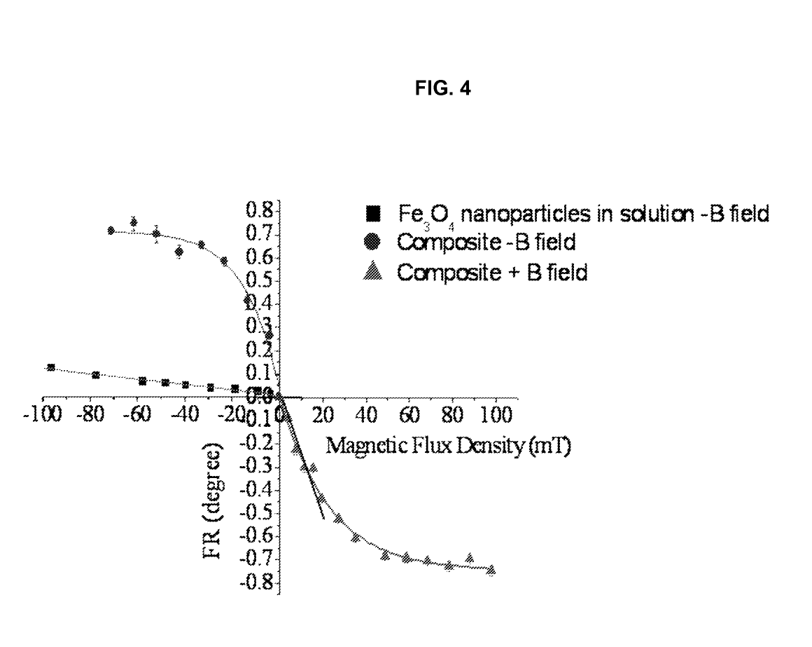

These and other data concerning DC Faraday rotation demonstrate that cooperative magnetic interactions among magnetic nanoparticles in the films enhance the MO properties of the films. The data also show that the Faraday rotation exhibited by an MNPC film is much greater than exhibited by a solution containing the same concentration and size distribution of nanoparticles, within a given interaction volume of the laser beam used for performing measurements of Faraday rotation). An exemplary comparison between the MNPC film and a corresponding solution is shown in FIG. 4, in which the data denoted by squares were obtained from a sample of Fe₃O₄ nanoparticles in solution exposed to a −B field; the data denoted by circular dots were obtained from an MNPC film in a −B field; and the data denoted by triangles were obtained from an MNPC film in a +B field. Note the substantially greater Faraday rotations exhibited by the MNPC films.

A plot such as that shown in FIG. 4 can be used to compute the magnetic moment size dₘₐₓ by normalizing the Faraday-rotation curve to obtain magnetic moments, of which the slopes are dM/dH:

$${d}_{max}^{3} = ( \frac{18 {k}_{B}}{η} ) ( \frac{1}{ρ {M}_{S}^{2}} ) {( \frac{d M}{d H} )}_{H \to 0}$$

Long-range magnetic ordering can be obtained within structures configured as rigid posts containing pristine or magnetically aligned MNPCs. However, the obtained magnetic ordering is often susceptible to size and shape of the particles. For maximum enhancements, the particles desirably have a highly monodisperse size distribution. These structural configurations are difficult to achieve by conventional methods performed with commercially available metal nanoparticles. Also, rigid-post structures are expensive to produce by conventional methods. Applicants have found that effective 1D and multi-dimensional structures, made up of self-ordered nanoparticles, can be readily made by the methods described herein. The external magnetic field, when applied to nanoparticles that have been rendered free to orient themselves and move about, results in the nanoparticles assuming ordered structures each comprising multiple superparamagnetic nanoparticles. The structures are 1D or multi-dimensional in conformation and are producible in a controlled manner. Removing the fluidization influence as the nanoparticles have assumed such structures causes the fluid matrix to rigidify and maintain the structures in a persistent manner.

Another advantage to the methods disclosed herein is the ability to produce the ordered structures of nanoparticles easily with relatively small applied magnetic fields. This “magnetic poling” is analogous to electrical poling, in which a relatively large electric field is applied to a material (containing electric dipoles) to induce alignment of the dipoles in the material. Electrical poling of a material is generally performed at a temperature several degrees above the T_{g} (glass transition temperature) of the material but not above the melting point of the material because the electric dipoles only experience minimal spatial movement when being influenced by the electrical field. Magnetic poling as used herein, on the other hand, is performed on an MNPC composite at a temperature at which the viscosity of the material is at a minimum (i.e., at a temperature above the melting point of the matrix material) to cause actual motion (alignment and/or migration) of the particles. For example, with poly-methacrylates, viscosity decreases with corresponding increases in temperature, and the viscosity generally reaches a minimum (“saturation”) at a temperature of about 20° C. greater than the melting point of the matrix material. Achieving the lowest viscosity in this manner ensures maximal ability of the particles to undergo spatial movement in the matrix and ensures the minimum diffusion volume of the nanoparticles.

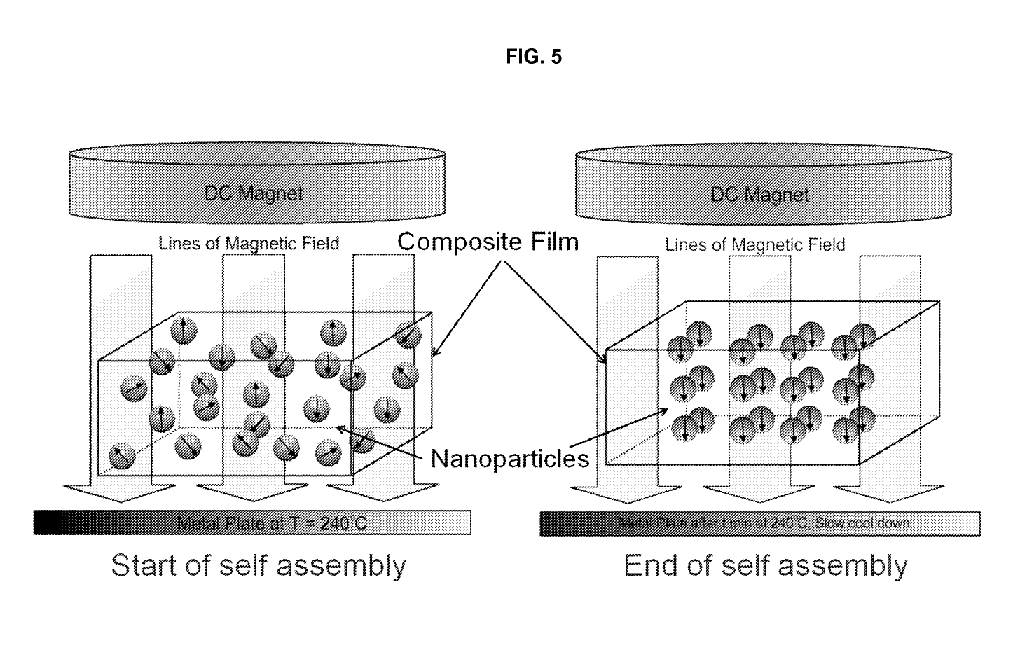

An exemplary schematic representation of magnetic poling is shown in FIG. 5. On the left-hand side, a pristine film of MNPC material is placed on a heated surface (e.g., metal plate) at a controlled temperature T=240° C. A DC magnet is placed such that the MNPC film is situated between the magnet and the metal plate. The magnetic lines of force extend from the magnet toward the metal plate. Initially, the nanoparticles are randomly dispersed in the MNPC matrix, as shown on the left. The right-hand portion of FIG. 5 shows the situation of the particles after the film has been at 240° C. for 1 minute without changing the position of either the metal plate or the magnet. Note that the nanoparticles not only have oriented themselves with the lines of magnetic force but have also formed multiple 1D structures (pillars or stacks) each comprising multiple nanoparticles. The stacks are also aligned with the lines of magnetic force. Upon slowly cooling the MNPC film shown on the right, the stacks become permanent structures in the polymer matrix. The resulting MNPC film with ordered nanoparticles can be used in an application that exploits their distinctive properties, such as MO properties.

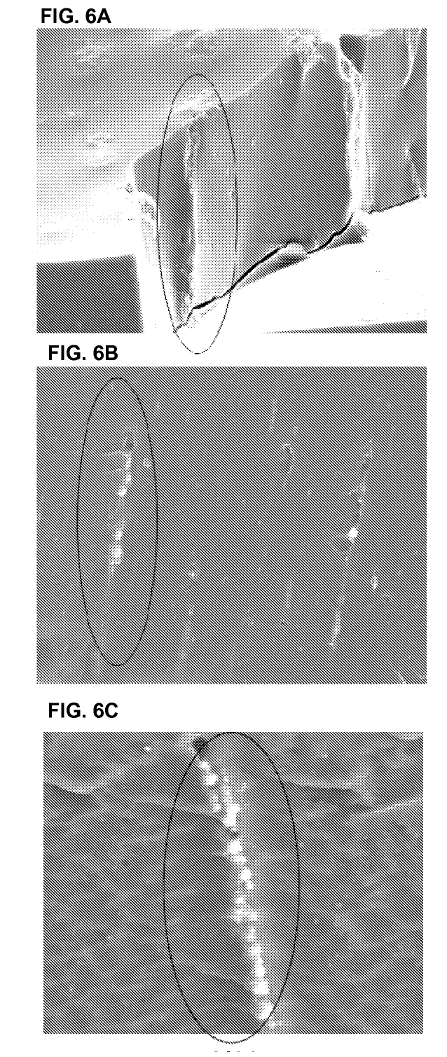

Exemplary sectional images obtained by scanning electron microscopy of a magnetically poled MNPC film are shown in FIGS. 6(A)-6(C). In the images the 1D stacks of Fe₃O₄ nanoparticles in the polymer matrix are clearly visible. Each stack (the ovals surround individual stacks) has large shape anisotropy (i.e., much longer in the vertical dimension than in the dimensions normal to the vertical dimension) typical of stacks and pillars. The diameter, orientation, length, and number of stacks per unit cubic volume of film are controllable by appropriately controlling the external applied magnetic field.

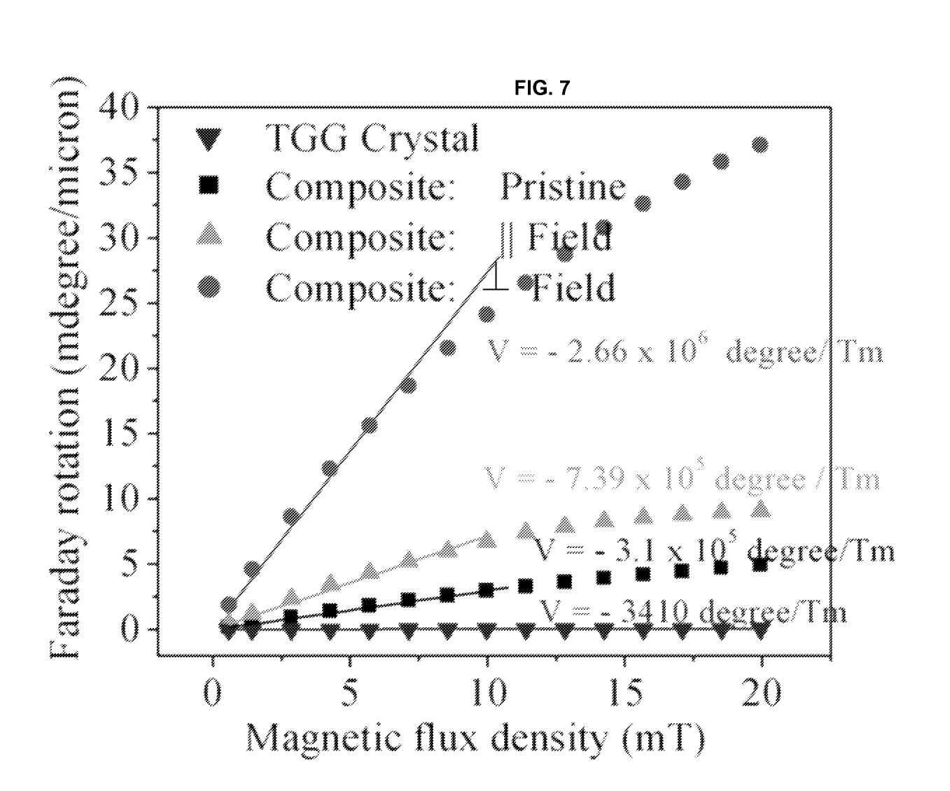

The anisotropic stacks of magnetic nanoparticles behave like ferromagnetic rods that have large permanent magnetizations. This behavior is confirmed by measurements of Faraday rotation performed on films before and after magnetic poling. Representative data are shown in FIG. 7, which depicts plots of Faraday rotation as functions of magnetic flux density in the applied magnetic field, wherein the wavelength was 980 nm. Each plot corresponds to a film having a different Verdet constant. The upside-down triangles denote data obtained from TGG crystal, serving as a control. The squares denote data obtained from a pristine composite. The upright triangles denote data obtained with a magnetically poled MNPC with a parallel applied magnetic field. The circles denote data obtained with a magnetically poled MNPC with a perpendicular applied magnetic field. These data clearly show that enhanced Faraday rotation is obtained as a result of magnetic poling. Note that the organization of the nanoparticles induced by the magnetic poling provides larger Verdet constants (as figures of merit). Note also that the magnetic poling of these films is an easy and simple process to perform. The Faraday rotations exhibited by these magnetically poled MNPC films are mathematically related to their respective bulk magnetizations, as expressed below.

From magnetization theory,

$$θ = ( \pm V ) ( \pm B ) L = π ( \frac{Δ n}{λ} )$$

$$V = 4 {π}^{2} {ω}^{2} \frac{{χ}_{m}}{g {μ}_{B} c ℏ} {\sum }_{ij} \frac{{C}_{ij}}{{ω}^{2} - {ω}_{j}^{2}}$$

$${χ}_{m} = {Np}^{2} \times \frac{{μ}_{B}^{2}}{3 {k}_{B}} \times \frac{1}{( T - {T}_{c} )}$$

$${χ}_{m} = {( \frac{\partial M}{\partial H} )}_{H \to 0}$$

wherein B is the magnitude of the magnetic field, L is the thickness of the MNPC film, Cᵢⱼ is the approximate oscillator strength, ω is the frequency of laser light used for performing measurements of Faraday rotation, ωⱼ is the resonance frequency, χ_{m is the magnetic susceptibility, M is magnetization, μ}_{B} is the Bohr magneton (sometimes denoted β), P is the individual magnetic moment, g is the Landé factor, and N is the number of nanoparticles.

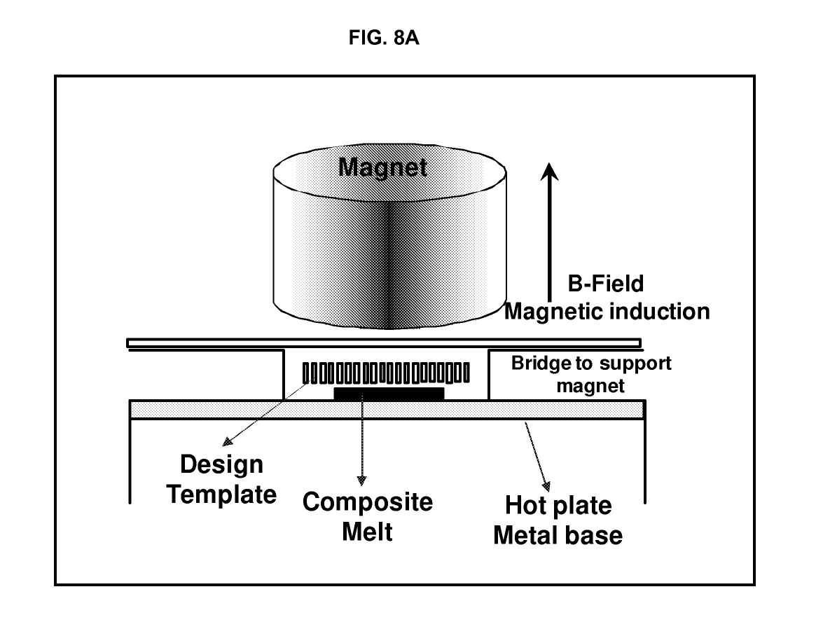

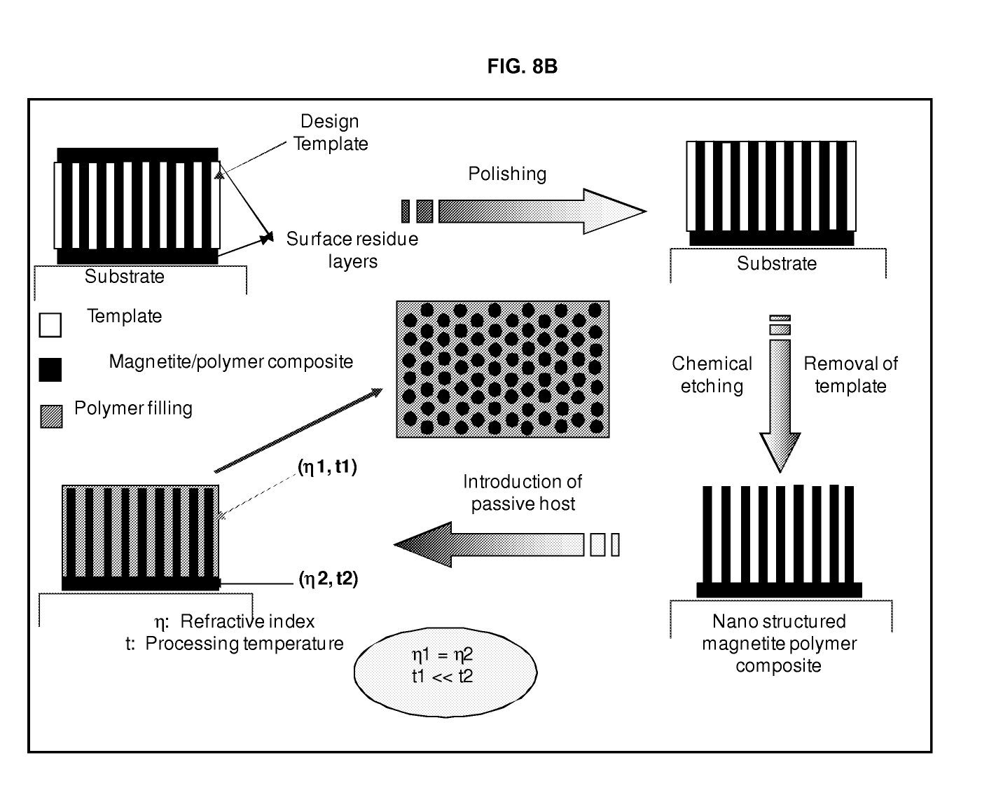

As an alternative to using magnetic poling to create three-dimensional ensembles of magnetic nanoparticles, it is also possible to form and dispose these stacks of nanoparticles in a suitable spatial pattern created and aided by a design template. A design template can be made of any material that is harder than the MNPC composites, such as silicon, silicon nitride, or alumina, for example. Holes with diameter and inter-hole distances ranging from 10 nm to several microns can be fabricated in the material using electron-beam or photolithographic techniques. Design templates are generally several hundreds of micrometers to several millimeters thick. This can be an effective way to prepare MO materials having particular specific properties. An embodiment of this process is shown in FIGS. 8(A) and 8(B). Turning first to FIG. 8(A), an MNPC film is situated on the surface of a metal hot plate adjusted to a desired melt temperature. A magnet pole is situated above the hot-plate surface, separated therefrom by a gap occupied by a bridge structure to support the magnet. Between the magnet pole and the MNPC film is a design template. Upon melting the MNPC becomes a viscous fluid and enters the holes in the design template as a result of capillary action. The applied magnetic field reorients and aligns the magnetic nanoparticles by physically moving them and aligning them along the magnetic lines of force. Once cooled down, the polymer host in the MNPC rigidifies, thereby freezing the positions of the aligned nanoparticles. The design template physically conforms the MNPC to the embedded template design. As a result, the magnetic nanoparticles in the MNPC film become oriented and ordered not just according to the applied magnetic field but also according to the pattern defined by the design template. Thus, the design template provides a way to form, on a consistent and predictable manner, a desired structure of associated and ordered nanoparticles in the MNPC film undergoing magnetic poling. Whereas the design template is advantageous in some embodiments, it is not required for all embodiments.

Turning now to FIG. 8(B), an exemplary manner is shown of using a design template for imparting a desired degree and order pattern to the nanoparticle structures as an MNPC film is being magnetically poled. Beginning in the upper left of the figure, the MNPC composite material (dark) is shown occupying vertical spaces between elements (white) of the design template. The upper and lower surfaces of the MNPC material can include surface residue layers. The lower surface rests on a substrate (e.g., controlled-temperature surface). Polishing the upper surface removes the upper surface of and planarizes the MNPC material. The remainder of the design template can be removed by chemical etching to produce the nano-structured MNPC structure shown in the lower right-hand corner of the figure. To this structure is added a “passive host” (gray) having substantially the same refractive index as the MNPC material (i.e., η₁=η₂), and having a fluid temperature t₁ that is much less than the melting point (t₂) of the MNPC material. The passive host fills the interstices of the nano-structured MNPC material, as shown in the lower left of the figure. A top view of the resulting structure is shown in the center of the figure.

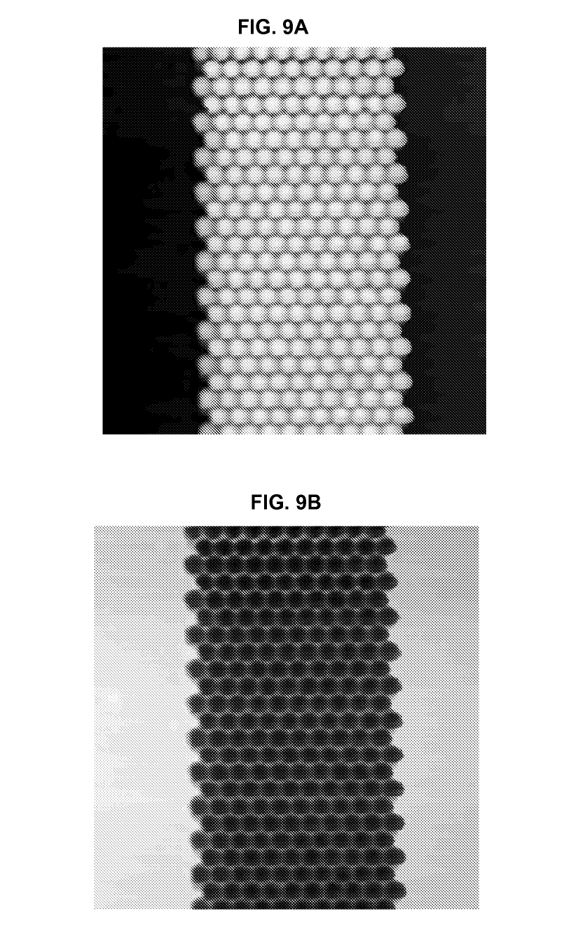

This method exploits the cooperative nature of the magnetization of the nanoparticles, which enhances the resultant MO properties. This method also exploits the flexibility of the polymer host material, which is a key advantage for producing MO devices. A large magnetic moment of, for example, a few thousands of Bohr magnetons (μ_{B}) applied to magnetic single-domain nanoparticles enhances their long-range interparticle interactions and allows comparisons with conventional spin-spin interactions at the atomic level in paramagnetic materials. For example, two magnetic nanoparticles of ˜40 nm (20,000μ_{B}) diameter separated by 80 nm have approximately 20 times greater interaction than atomic moments of 3 μL_{B} separated by 0.6 nm (typical inorganic spin systems). Spatially ordered nanoparticles resulting from magnetic poling also reduces optical loss due to absorption, since better ordering reduces the optically exposed volume of the embedded nanoparticles. We have also fabricated columnar arrangements of stacked nanoparticles (FIG. 8(B)), wherein each stack has a high aspect ratio (as high as 1000 to date) in the polymer matrix. When viewed from above, the stacks are disposed in, for example, a body-centered hexagonal arrangement (FIG. 8(B), center). The nano-structured material can be embedded in a non-magnetic matrix that has a refractive index matched to the polymer to circumvent light scattering. In any event, the resulting nano-structured MNPC materials have predictably optimized properties, such as MO properties, for specialized applications.

Whereas nanoparticles and dense nanoparticle assemblies are generally not usable for magnetic data recording, one may use the magnetic poling approach disclosed herein, aided by nano-imprinting, to construct nano-structured media in which each metal structure (e.g., stack of nanoparticles) can be addressed as a single magnetic bit. An exemplary structure is shown in FIGS. 9(A) and 9(B). FIG. 9(A) is a topographic (surface) image of a photonic crystal type of structure prepared from pristine Fe₃O₄ PMMA composite using this nano-imprinting technique. FIG. 9(B) is a magnetic force microscopy (MFM) image of the same film. The individual pillars of nanoparticles in this structure can be separately addressed magnetically. I.e., individual pillars can be individually magnetically poled using a magnet tip. In the figure, darker color in the MFM image (FIG. 9B)) denotes repulsion between the magnetic tip and the sample.

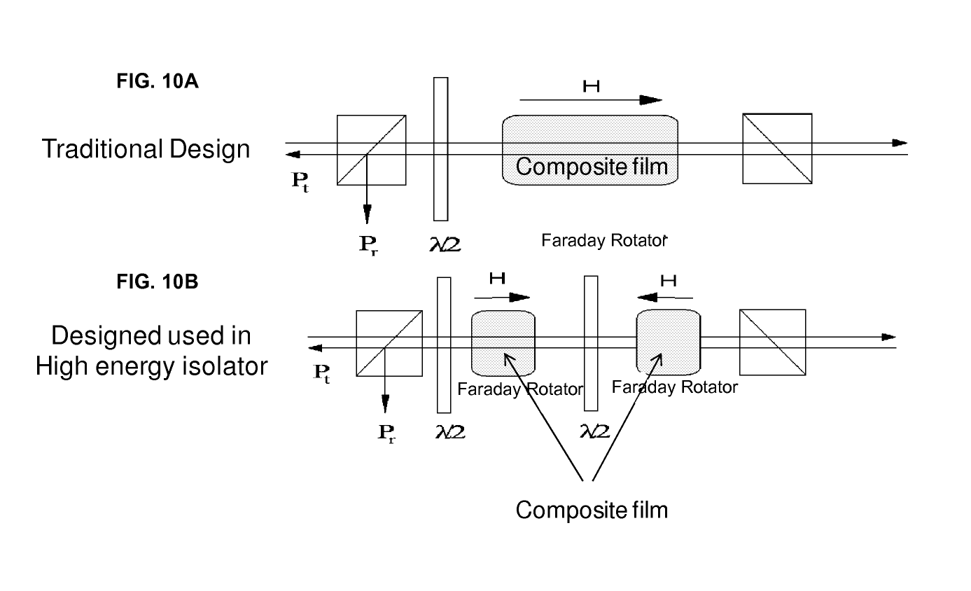

MNPC composites as described above, particularly MNPC composites that have been magnetically poled in the desired manner, have immediate application in the manufacture of optical isolators and magnetic-field sensors, for example. Either can be produced in any of various specific configurations such as but not limited to waveguides, evanescent waveguides, bulk nano-structured magnetically poled films, and melt-filled hollow or holey fibers. Holey fibers are fibers having air holes arranged in a particular fashion within the fiber cross-section. In some instances it is beneficial to have these holes provide a particular photonic band gap. An exemplary embodiment of an optical isolator is shown in FIGS. 10(A) and 10(B). The performance of the optical isolator is based on Faraday rotation as produced in an MNPC film. In FIG. 10(A) a light beam input from the left traverses a polarizer, a λ/2-wave (half-wave) plate, and a unit of the magnetically poled MNPC film to which a longitudinal magnetic field H is applied. Reflected light that returns through the second polarizer undergoes sufficient Faraday rotation in the film to be rejected at the first polarizer. An alternative embodiment specifically tailored for high-power applications is shown in FIG. 10(B). Fiber-based embodiments can be produced in which the MNPC melt is filled into an appropriately configured capillary made of fused silica or into a holey fiber. Flow of the MNPC melt can be facilitated by applying a magnetic field. The resulting structure can be sealed off and spliced to other fiber-based components.

Exemplary applications of MNPC materials as disclosed herein include, but are not limited to, the following:

MO isolators: An MO isolator allows polarized light to travel only, for example, in a forward direction while blocking light propagation in the reverse direction. An MO isolator comprises a respective polarizer at each of the two ends of an MO material, with the primary axes of the polarizers being oriented at 45° relative to each other. MO isolators are integral parts of many types of optical-communications lasers, and are used as, for example, as safeguards against unwanted back reflections. Certain self-assembled MNPCs, having Verdet constants as large as ˜10⁶°/Tm, may allow construction of MO isolators that are only 300-1000 μm in length. The MO isolators can be configured for use in free space, in-fiber, and integrated waveguide geometries.

Magnetic-field sensors: Organized MNPCs can be used in various magnetic-field sensors, such as but not limited to satellite altitude monitors, magnetic-field uniformity probes, sensitive engine monitors, electrical power sensors and monitors, pacemaker warning devices, etc.

Magnetic photonic crystals: An MNPC material fabricated into a photonic crystal-type structure can be used in a polarization switch and/or a diffraction grating controlled by an external applied magnetic field. Magnetic photonic crystals are also usable in various metamaterials. Rasing et al., “Magnetic Photonic Crystals,” J. Phys. D: Appl. Phys. 36:R277-R287 (2003).

Magnetic data recording: An MNPC material can be fabricated using the magnetic-field-induced assembly technique disclosed herein for use in magnetic data recording.

Whereas the invention has been described in connection with representative embodiments, it will be understood that it is not limited to those embodiments. On the contrary, it is intended to encompass all alternatives, modifications, and equivalents as may be included within the spirit and scope of the invention as defined by the appended claims.

What is claimed is:

1. A method for producing a magnetic-nanoparticle-polymer composite (MNPC) material, comprising:
preparing a suspension of magnetic nanoparticles in a carrier in which the nanoparticles are not soluble, the nanoparticles being individually magnetically polar, the carrier being sufficiently fluid to allow movement of the nanoparticles in the carrier, and the carrier being formulated to form a rigid polymer matrix for the nanoparticles whenever a rigidification condition is applied to the carrier;
when the carrier is sufficiently fluid to allow movement of the nanoparticles in the carrier, exposing the suspension to an external magnetic field having a magnitude sufficient to align at least some of the nanoparticles with the magnetic field and cause self-assembly of at least some of the nanoparticles with each other to form multiparticulate structures in the carrier; and
applying a rigidification condition to the suspension of nanoparticles to rigidify the carrier into the polymer matrix, thereby forming a rigid MNPC material in which the polymer matrix is sufficiently rigid to freeze respective positions and orientations assumed by the nanoparticles in the polymer matrix.

2. The method of claim 1, further comprising:
after preparing the suspension of magnetic nanoparticles in the carrier, applying a pre-rigidifying condition to the suspension to rigidify the carrier; and
before exposing the suspension of magnetic nanoparticles to the external magnetic field, applying a fluidization condition to the suspension to liquefy the carrier sufficiently to allow movement of the nanoparticles in the carrier.

3. The method of claim 2, wherein the carrier is a liquid solution of a solvent and molecules of at least one monomer that are soluble in the solvent and, when exposed to either rigidification condition, form molecules of a polymer.

4. The method of claim 2, wherein:
exposure to the external magnetic field is performed after exposing the suspension to the pre-rigidificatioin condition; and
exposing the suspension to a pre-rigidification condition results in formation of a pristine MNPC material in which the nanoparticles are suspended in the polymer matrix.

5. The method of claim 1, wherein self-assembly produces at least substantially one-dimensional aggregations of nanoparticles in the polymer matrix.

6. The method of claim 5, wherein self-assembly also produces arrangements of the one-dimensional aggregations that are at least two-dimensional in the polymer matrix.

7. The method of claim 1, wherein the carrier is a liquid solution of a solvent and molecules of at least one polymer that are soluble in the solvent and, when exposed to a rigidification condition, form a rigid matrix of the polymer.

8. The method of claim 1, wherein applying the rigidification condition to the suspension of nanoparticles further comprises continuing application of the external magnetic field to the suspension until the respective positions and orientations assumed by the nanoparticles in the polymer matrix are frozen.

9. A method for producing a magnetic-nanoparticle-polymer composite (MNPC) material, comprising:
preparing a liquid suspension of magnetic nanoparticles in a carrier liquid in which the nanoparticles are not soluble, the nanoparticles being sufficiently magnetically polar to be alignable with the magnetic field, the carrier liquid being sufficiently fluid to allow movement of the nanoparticles in the carrier liquid, and the carrier liquid being formulated to form a rigid polymer matrix for the nanoparticles whenever the carrier liquid is exposed to a rigidification condition;
applying a first rigidification condition to the suspension of nanoparticles to rigidify the carrier liquid into the polymer matrix and thus form a rigid MNPC material;
applying a fluidizing condition to the rigid MNPC material to fluidize the polymer matrix sufficiently to allow movement of the nanoparticles in the liquefied polymer matrix;
while the polymer matrix is fluid, magnetically poling the MNPC material by exposing the MNPC material to a magnetic field having a magnitude sufficient to cause at least some of the nanoparticles therein to become magnetically aligned with the magnetic field and to self-assemble with each other; and
while continuing to magnetically pole the MNPC material, applying a second rigidification condition to the MNPC material to freeze further movement of the nanoparticles in the polymer matrix.

10. The method of claim 9, wherein the carrier liquid is a solution of at least one monomer and at least one solvent in which molecules of the monomer are soluble.

11. The method of claim 10, wherein the first rigidification condition is conducive for polymerization of molecules of the at least one monomer.

12. The method of claim 9, wherein the carrier liquid is a solution of at least one polymer and at least one solvent in which molecules of the polymer are soluble.

13. The method of claim 12, wherein the first rigidification condition includes removal of at least some of the solvent from the liquid suspension.

14. The method of claim 9, wherein the fluidization condition comprises applying heat to the rigid MNPC material.

15. The method of claim 9, wherein the second rigidification condition comprises removing heat from the liquefied MNPC material.

16. The method of claim 9, wherein magnetic poling applied to the fluid MNPC material is further sufficient to cause at least some of the nanoparticles to spatially self-assemble with each other into nanostructures including at least 1D nano structures.

17. The method of claim 9, wherein magnetic poling of the liquid MNPC material is sufficient to cause at least some of the nanoparticles to self-organize into ordered structures.

18. The method of claim 17, wherein the ordered structures comprise substantially one-dimensional pillars of self-organized nanoparticles.

19. The method of claim 17, wherein the ordered structures further comprise substantially multi-dimensional assemblies of the self-organized nanoparticles.

20. The method of claim 9, further comprising, while magnetically poling the MNPC material, applying a pattern template to the MNPC material to guide at least one of magnetic alignment and self-assembly of the nanoparticles.

21. The method of claim 20, wherein the pattern template shapes the magnetic field passing through the liquid MNPC material.

22. The method of claim 9, wherein, during the second rigidification condition, the magnetic field is different from the magnetic field applied during magnetic poling of the liquid MNPC material.

23. A method for producing a magnetic-nanoparticle-polymer composite (MNPC) material, comprising:
producing a pristine MNPC material comprising magnetic nanoparticles suspended in a polymer matrix;
exposing at least one portion of the pristine MNPC material to a fluidizing condition to liquefy the polymer matrix in the at least one portion, the liquefaction being sufficient to allow movement of the nanoparticles in the matrix;
during exposure to the fluidizing condition, magnetically poling the at least one portion to magnetically align the constituent nanoparticles with a magnetic field applied to the at least one portion and to cause at least some of the nanoparticles in the at least one portion to self-assemble with each other; and
while continuing the magnetic poling, exposing the at least one portion to a rigidification condition to freeze further movement of the nanoparticles in the at least one portion.

24. An MNPC material formed by the method recited in claim 1.

25. An MNPC material formed by the method recited in claim 9.

26. An MNPC material formed by the method recited in claim 21.

27. A unit of magnetic-nanoparticle-polymer composite (MNPC) material, comprising a rigid polymer matrix and multiple magnetic nanoparticles in the matrix, at least some of the magnetic nanoparticles being commonly magnetically oriented, and at least some of the magnetic nanoparticles being self-assembled into structures in the matrix, the structures including at least substantially one-dimensional stacks of the nanoparticles.

28. The unit of MNPC material of claim 27, wherein the stacks are substantially parallel with each other in at least one region of the matrix.

29. The unit of MNPC material of claim 27, exhibiting a Faraday rotation greater than an otherwise similar unit of an MNPC material in which the nanoparticles are not self-assembled.

30. A magneto-optical (MO) device, comprising a unit of magnetic-nanoparticle-polymer composite (MNPC) material comprising a rigid polymer matrix and multiple magnetic nanoparticles in the matrix, at least some of the magnetic nanoparticles being commonly magnetically oriented, and at least some of the magnetic nanoparticles being self-assembled into structures in the matrix, the structures including at least an array of substantially one-dimensional stacks of the nanoparticles.

31. The MO device of claim 30, selected from the group consisting of MO isolators, magnetic-field sensors, magnetic photonic crystals, and magnetic data-recording devices.

32. A magnetic-nanoparticle-polymer composite (MNPC) material, comprising:
multiple magnet nanoparticles; and
a rigid polymer matrix,
wherein the nanoparticles are suspended in the polymer matrix,
the polymer matrix exhibits an optical loss of less than 1 dB/cm at an operational wavelength for the polymer matrix,
a refractive index within approximately 0.03 of the refractive index of the nanoparticles, and
a birefringence of less than 0.001, and
wherein at least some of the nanoparticles suspended in the polymer matrix are oriented to an external magnetic field and are organized into at least substantially one-dimensional aggregations of nanoparticles.
